(19) United States
(12) Patent Application Publication
(10) Pub. No.: US 2018/0337623 A1
(43) Pub. Date: Nov. 22, 2018

(54) DRIVE DEVICE AND CONTROL METHOD FOR DRIVE DEVICE

(71) Applicant: TOYOTA JIDOSHA KABUSHIKI KAISHA, Toyota-shi (JP)

(72) Inventor: Takashi OTA, Seto-shi, Aichi-ken (JP)

(73) Assignee: TOYOTA JIDOSHA KABUSHIKI KAISHA, Toyota-shi (JP)

(21) Appl. No.: 15/979,898

(22) Filed: May 15, 2018

(30) Foreign Application Priority Data
May 19, 2017 (JP) 2017-099419

(51) Int. Cl. H02P 21/09

(52) U.S. Cl. CPC H02P 21/09

(57) ABSTRACT

An electronic control unit controls an inverter by pulse width modulation control. The electronic control unit performs first control of setting voltage commands of a d axis and a q axis based on a torque command for a motor and a detected electrical angle of the motor which is detected by a detection unit at intervals of one cycle of a carrier wave. The electronic control unit performs second control including control of calculating a predicted electrical angle at intervals of a half cycle of the carrier wave.

### INCORPORATION BY REFERENCE

The disclosure of Japanese Patent Application No. 2017-099419 filed on May 19, 2017 including the specification, drawings and abstract is incorporated herein by reference in its entirety.

### BACKGROUND

### 1. Technical Field

The disclosure relates to a drive device and a control method for a drive device and more particularly to a drive device including a motor and an inverter and a control method for a drive device.

### 2. Description of Related Art

In the related art, a drive device that controls an inverter for driving a motor by PWM control and that sets a control angle cycle in which a PWM signal is generated to an angle (2π/K) obtained by dividing one phase cycle (2π) of a voltage command vector by a synchronization number (the number of triangular waves) K when full cycle control is performed and to a half angle (π/K) thereof when half cycle control is performed has been proposed (for example, see Japanese Unexamined Patent Application Publication No. 2012-95485 (JP 2012-95485 A)). In such a drive device, the phase of a start point of the control angle cycle is defined as an interruption phase, a phase current and an electrical angle of the motor are acquired at the time of the interruption phase, and the voltage command vector is generated using the acquired data. The PWM signal is generated using a predicted phase which leads the interruption phase by a predetermined angle (1.5π/K in the case of half cycle control and 1.25π/K and 1.75π/K in the case of full cycle control) and the voltage command vector.

### SUMMARY

In the drive device, when half cycle control is performed by a control unit that controls the inverter and the frequency of triangular waves (a carrier frequency) is high, a processing load of the control unit may exceed an allowable load and the PWM signal may not be appropriately set. On the other hand, when full cycle control is performed by the control unit, the processing load of the control unit can be reduced in comparison with the case of half cycle control, but the time interval of the control angle cycle increases and thus controllability of the motor is likely to deteriorate.

The disclosure provides a drive device and a control method for a drive device that can allow both curbing of increase in a processing load of a control unit and securing of controllability of a motor.

The drive device according to the disclosure employs the following configurations for the above-mentioned main purpose.

A first aspect of the disclosure provides a drive device. The drive device includes a motor, an inverter configured to drive the motor by switching a plurality of switching elements, and an electronic control unit. The electronic control unit is configured to detect an electrical angle of the motor as a detected electrical angle. The electronic control unit is configured to control the inverter by pulse width modulation control. The electronic control unit is configured to perform first control at intervals of one cycle of a carrier wave. The first control is control of setting voltage commands of a d axis and a q axis based on a torque command for the motor and the detected electrical angle. The electronic control unit is configured to perform second control at intervals of a half cycle of the carrier wave. The second control is control including control of calculating a predicted electrical angle based on the detected electrical angle. The predicted electrical angle is used to generate a pulse width modulation signal.

With this configuration, the electronic control unit is configured to control the inverter by the pulse width modulation control. The electronic control unit is configured to perform the first control of setting the voltage commands of the d axis and the q axis based on a torque command for the motor and the detected electrical angle which is an electrical angle of the motor detected by a detection unit at intervals of the one cycle of the carrier wave. The electronic control unit is configured to perform second control including control of calculating a predicted electrical angle, which is used to generate a pulse width modulation signal, based on the detected electrical angle at intervals of the half cycle of the carrier wave. Accordingly, it is possible to curb increase in a processing load of the electronic control unit by causing the electronic control unit to perform the first control at intervals of the one cycle of the carrier wave. It is possible to secure controllability of the motor by causing the electronic control unit to perform the second control at intervals of the half cycle of the carrier wave. That is, it is possible to allow both curbing of increase in a processing load of the electronic control unit and securing of controllability of the motor.

In the drive device, the electronic control unit may be configured to perform the first control at intervals of the one cycle of the carrier wave when a frequency of the carrier wave is equal to or greater than a predetermined frequency. The electronic control unit may be configured to perform the first control at intervals of the half cycle of the carrier wave when the frequency of the carrier wave is less than the predetermined frequency. With this configuration, when the frequency of the carrier wave is less than the predetermined frequency, it is possible to make controllability of the motor better. In the drive device, the electronic control unit may be configured to perform the first control at intervals of the one cycle of the carrier wave when synchronous pulse width modulation control of the pulse width modulation control is performed and the frequency of the carrier wave is equal to or greater than the predetermined frequency. The electronic control unit may be configured to perform the first control at intervals of the half cycle of the carrier wave either when asynchronous pulse width modulation control of the pulse width modulation control is performed or when the frequency of the carrier wave is less than the predetermined frequency.

In the drive device, the electronic control unit may be configured to set a frequency of the carrier wave such that the frequency of the carrier wave when a rotation speed of the motor is high is greater than the frequency of the carrier wave when the rotation speed of the motor is low. In this case, effects based on execution of the first control at intervals of the one cycle of the carrier wave and execution of the second control at intervals of the half cycle of the carrier wave become more marked when the rotation speed of the motor is relatively high.

A second aspect of the disclosure provides a control method for a drive device. The drive device includes a motor, an inverter configured to drive the motor by switching a plurality of switching elements, and an electronic control unit. The control method includes: detecting, by the electronic control unit, an electrical angle of the motor as a detected electrical angle; controlling, by the electronic control unit, the inverter by pulse width modulation control; performing, by the electronic control unit, first control of setting voltage commands of a d axis and a q axis based on a torque command for the motor and the detected electrical angle at intervals of one cycle of a carrier wave; and performing, by the electronic control unit, second control including control of calculating a predicted electrical angle based on the detected electrical angle at intervals of a half cycle of the carrier wave, the predicted electrical angle being used to generate a pulse width modulation signal.

With this configuration, it is possible to curb increase in a processing load of the electronic control unit by causing the electronic control unit to perform the first control at intervals of the one cycle of the carrier wave. It is possible to secure controllability of the motor by causing the electronic control unit to perform the second control at intervals of the half cycle of the carrier wave. That is, it is possible to allow both curbing of increase in a processing load of the electronic control unit and securing of controllability of the motor.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating a configuration of an electric vehicle 20 in which a drive device according to an embodiment of the disclosure is mounted;

FIG. 2 is a diagram illustrating an example of a relationship between a rotation speed Nm of a motor 32, a carrier frequency fc, and a synchronous PWM control flag F;

FIG. 3 is a diagram illustrating a state in which a PWM signal is generated when an acquisition arithmetic process and a second arithmetic process are performed at intervals of a half cycle of a carrier wave by a microcomputer 51 of an electronic control unit 50;

FIG. 4 is a flowchart illustrating an example of an execution interval setting routine that is performed by the microcomputer 51 of the electronic control unit 50;

FIG. 5 is a diagram illustrating a state in which a PWM signal is generated when the acquisition arithmetic process and the second arithmetic process are performed at intervals of one cycle of a carrier wave by the microcomputer 51 of the electronic control unit 50; and

FIG. 6 is a diagram schematically illustrating times at which the acquisition arithmetic process, a first arithmetic process, and the second arithmetic process are performed by the microcomputer 51 of the electronic control unit 50.

### DETAILED DESCRIPTION OF EMBODIMENTS

Hereinafter, an embodiment of the disclosure will be described with reference to the accompanying drawings.

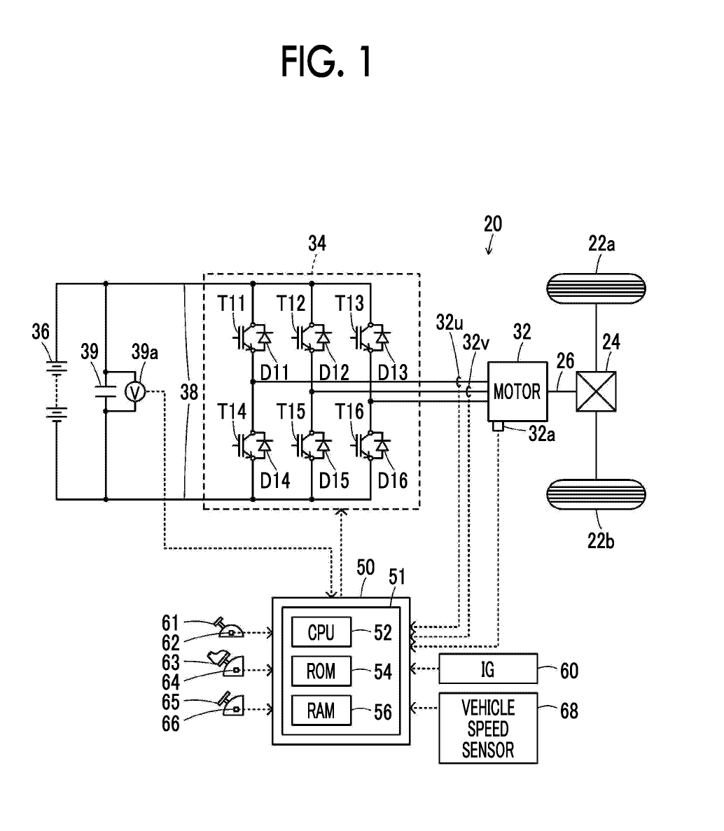

FIG. 1 is a diagram schematically illustrating a configuration of an electric vehicle 20 in which a drive device according to an embodiment of the disclosure is mounted. As illustrated in the drawing, the electric vehicle 20 according to the embodiment includes a motor 32, an inverter 34, a battery 36 serving as a power storage device, and an electronic control unit 50.

The motor 32 is configured as a three-phase synchronous generator motor and includes a rotor that has a permanent magnet embedded therein and a stator on which three-phase coils are wound. The rotor of the motor 32 is connected to a drive shaft 26 which is connected to driving wheels 22a and 22b via a differential gear 24.

The inverter 34 is used to drive the motor 32. The inverter 34 is connected to the battery 36 via power lines 38 and includes six transistors T11 to T16 which are switching elements and six diodes D11 to D16 that are connected in parallel to the six transistors T11 to T16. The transistors T11 to T16 are arranged in pairs of two transistors to serve as a source side and a sink side with respect to a positive electrode line and a negative electrode line of the power lines 38. Each junction between the transistors constituting a pair in the transistors T11 to T16 is connected to the corresponding three-phase coil (a U phase, a V phase, or a W phase) of the motor 32. Accordingly, when a voltage is applied to the inverter 34, an ON-time ratio of the transistors T11 to T16 constituting each pair is adjusted by the electronic control unit 50, whereby a rotating magnetic field is formed in the three-phase coils and the motor 32 is rotationally driven. Hereinafter, the transistors T11 to T13 may be referred to as an “upper arm” and the transistors T14 to T16 may be referred to as a “lower arm.”

The battery 36 is configured, for example, as a lithium-ion secondary battery or a nickel-hydride secondary battery and is connected to the inverter 34 via the power lines 38 as described above. A capacitor 39 is attached to the positive electrode line and the negative electrode line of the power lines 38.

The electronic control unit 50 is configured as a microcomputer 51 including a CPU 52, a ROM 54, a RAM 56, and input and output ports. Signals from various sensors are input to the electronic control unit 50 via the input port. Examples of the signals input to the electronic control unit 50 include a rotational position Om from a rotational position sensor (for example, a resolver) 32a that detects a rotational position of the rotor of the motor 32 and phase currents Iu and Iv from current sensors 32u and 32v that detect phase currents of phases in the motor 32. Examples thereof further include a voltage Vb of the battery 36 from a voltage sensor (not illustrated) that is attached between the terminals of the battery 36, a current 1b of the battery 36 from a current sensor (not illustrated) that is attached to the output terminal of the battery 36, and a voltage VH of the capacitor 39 (the power lines 38) from a voltage sensor 39a that is attached between the terminals of the capacitor 39. Examples thereof further include an ignition signal from an ignition switch 60, a shift position SP from a shift position sensor 62 that detects an operation position of a shift lever 61, an accelerator operation amount Acc from an accelerator pedal position sensor 64 that detects an amount of depression of an accelerator pedal 63, a brake pedal position BP from a brake pedal position sensor 66 that detects an amount of depression of a brake pedal 65, and a vehicle speed V from a vehicle speed sensor 68. Switching control signals to the transistors T11 to T16 of the inverter 34 are output from the electronic control unit 50 via the output port.

In the electric vehicle 20 according to the embodiment having the above-mentioned configuration, the electronic control unit 50 sets a required torque Td* for the drive shaft 26 based on the accelerator operation amount Acc and the vehicle speed V, and sets the set required torque Td* as a torque command Tm* for the motor 32. Then, the electronic control unit 50 controls the transistors T11 to T16 of the inverter 34 using the torque command Tm* for the motor 32 by pulse width modulation control (PWM control). Here, the PWM control is control of adjusting ON-time ratios of the transistors T11 to T16 by comparison voltage commands of the phases of the motor 32 with carrier waves (triangular waves).

Now, control of inverter 34 by the electronic control unit 50 will be described. At the time of control of the inverter 34, PWM signals for the transistors T11 to T16 are generated by causing the microcomputer 51 of the electronic control unit 50 to perform acquisition arithmetic processes (A1) to (A3), first arithmetic processes (B1) to (B3), and second arithmetic processes (C1) to (C3). The PWM signals from the microcomputer 51 are output to the inverter 34 by hardware (for example, a driver circuit) of the electronic control unit 50 which is not illustrated: (A1) a process of acquiring the rotational position θm of the rotor of the motor 32 from the rotational position sensor 32a and acquiring the phase currents Iu and Iv of the phases of the motor 32 from the current sensors 32u and 32v; (A2) a process of calculating an electrical angle θe or a rotation speed Nm of the motor 32 based on the rotational position θm of the rotor of the motor 32; (A3) a process of setting a frequency of a carrier wave (hereinafter referred to as a “carrier frequency”) fc based on the rotation speed Nm of the motor 32 and setting a synchronous PWM control flag F (a flag for selecting whether synchronous PWM control of synchronous PWM control and asynchronous PWM control should be performed); (B1) a process of converting (three-two phase conversion) the phase currents Iu and Iv of the phases of the motor 32 into currents Id and Iq of a d axis and a q axis using the electrical angle θe of the motor 32 calculated in (A2); (B2) a process of setting current commands Id* and Iq* of the d axis and the q axis based on the torque command Tm* for the motor 32; (B3) a process of setting voltage commands Vd* and Vq* of the d axis and the q axis based on the currents Id and Iq and the current commands Id* and Iq* of the d axis and the q axis; (C1) a process of calculating a predicted electrical angle θees by adding a predetermined electrical angle Δθe to the electrical angle θe of the motor 32 calculated in (A2); (C2) a process of converting (two-three phase conversion) the voltage commands Vd* and Vq* of the d axis and the q axis into voltage commands Vu*, Vv*, and Vw* of the phases using the predicted electrical angle θees; and (C3) a process of generating PWM signals for the transistors T11 to T16 using the voltage commands Vu*, Vv*, and Vw* of the phases and carrier waves.

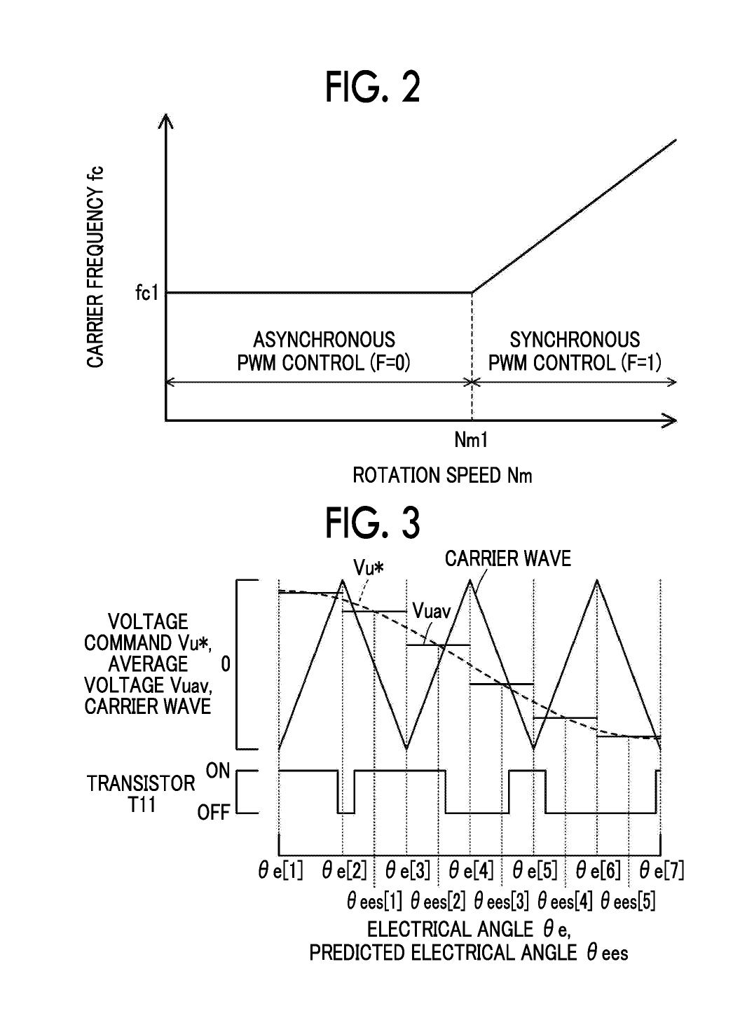

First, the process of (A3) will be described. In this process, in the embodiment, the carrier frequency fc and the synchronous PWM control flag F are set by applying the rotation speed Nm of the motor 32 to a predetermined relationship between the rotation speed Nm of the motor 32, the carrier frequency fc, and the synchronous PWM control flag F. FIG. 2 is a diagram illustrating an example of the relationship. In FIG. 2, in an area in which the rotation speed Nm of the motor 32 is less than a predetermined rotation speed Nm1, the carrier frequency fc1 is set to a predetermined frequency fc1, and the synchronous PWM control flag F is set to a value of zero (asynchronous PWM control is selected). In an area in which the rotation speed Nm of the motor 32 is equal to or greater than the predetermined rotation speed Nm1, the carrier frequency fc is set to increase from the carrier frequency fc with a slope at which a synchronization number Ns can be maintained at a predetermined value Ns1 (for example, a value of 6) as the rotation speed Nm of the motor 32 increases, and the synchronous PWM control flag F is set to a value of 1 (synchronous PWM control is selected). For example, 9,500 rpm, 10,000 rpm, or 10,500 rpm can be used as the predetermined rotation speed Nm1. For example, 4.7 kHz, 5 kHz, or 5.3 kHz can be used as the predetermined frequency fc1. The value of 6 which is a minimum value of values (the values of 6, 9, 12 , . . . ) with which symmetry of three-phase voltages supplied to the motor 32 can be guaranteed is used as the predetermined value Ns1. The reason for setting the carrier frequency fc and the synchronous PWM control flag F in this way is as follows. In an area in which the rotation speed Nm of the motor 32 is not relatively great, there is a likelihood that the carrier frequency fc will decrease and controllability of the motor 32 will deteriorate when the synchronization number Ns is maintained at the predetermined value Ns1 and the synchronous PWM control is performed, but controllability of the motor 32 can be enhanced when the carrier frequency fc is maintained at the predetermined value fc1 and asynchronous PWM control is performed. In an area in which the rotation speed Nm of the motor 32 is great, there is a likelihood that the number of carrier waves per one cycle (one cycle of the voltage commands Vu*, Vv*, and Vw* of the phases) at the electrical angle θe of the motor 32 will decrease and controllability of the motor 32 will deteriorate when the carrier frequency fc is maintained at the predetermined value fc1 and the synchronous PWM control is performed, but controllability of the motor 32 can be enhanced when the synchronization number Ns is maintained at the predetermined value Ns1 and the synchronous PWM control is performed.

The processes of (C1) to (C3) will be described below. Regarding the process of (C1), in the embodiment, an angle corresponding to 1.5 times an execution interval of the second arithmetic process is used as the predetermined electrical angle Δθe. FIG. 3 is a diagram illustrating a state in which a PWM signal is generated when the acquisition arithmetic process and the second arithmetic process are performed at intervals of a half cycle of a carrier wave (specifically, times of crests and troughs of a carrier wave) by the microcomputer 51 of the electronic control unit 50. In FIG. 3, a numeral in the predicted electrical angle θees[ ] of the motor 32 means that it has been calculated based on the same numeral in [ ] of the electrical angle θe of the motor 32. For example, the predicted electrical angle θees[1] of the motor 32 means that it has been calculated based on the electrical angle θe[1] of the motor 32. In FIG. 3, the predicted electrical angle θees has a value which leads the electrical angle θe by a ¾ cycle of the carrier wave. The processes of (C1) to (C3) will be described below with reference to FIG. 3. When an electrical angle θe (a value θe[i]) of the motor 32 is acquired by the process of (A1) at the times of crests and troughs of the carrier wave, the microcomputer 51 calculates the predicted electrical angle θees (a value θees[i]) based on the electrical angle θe of the motor 32 through the process of (C1). Subsequently, the microcomputer 51 converts the voltage commands Vd* and Vq* of the d axis and the q axis into the voltage commands Vu*, Vv*, and Vw* of the phases using the predicted electrical angle θees of the motor 32 through the process of (C2). Accordingly, the voltage commands Vu*, Vv*, and Vw* of the phases have values when the predicted electrical angle θees has the value θees[i]. In the process of (C3), the voltage commands Vu*, Vv*, and Vw* of the phases are set to average voltages Vuav, Vvav, and Vwav of a target section (a section of the electrical angle θe[i+1] to θe[i+2]) to which the predicted electrical angle θees (the value θees[i]) belongs, and the PWM signal for the transistors T11 to T16 in the target section is generated using the average voltages Vuav, Vvav, and Vwav and the carrier wave. At this time, the PWM signal in the target section may be generated by comparison of the average voltages Vuav, Vvav, and Vwav with the carrier wave, or a duty ratio of the target section may be set based on the average voltages Vuav, Vvav, and Vwav and the voltages of the crest and the trough of the carrier wave and the PWM signal in the target section may be generated based on the duty ratio.

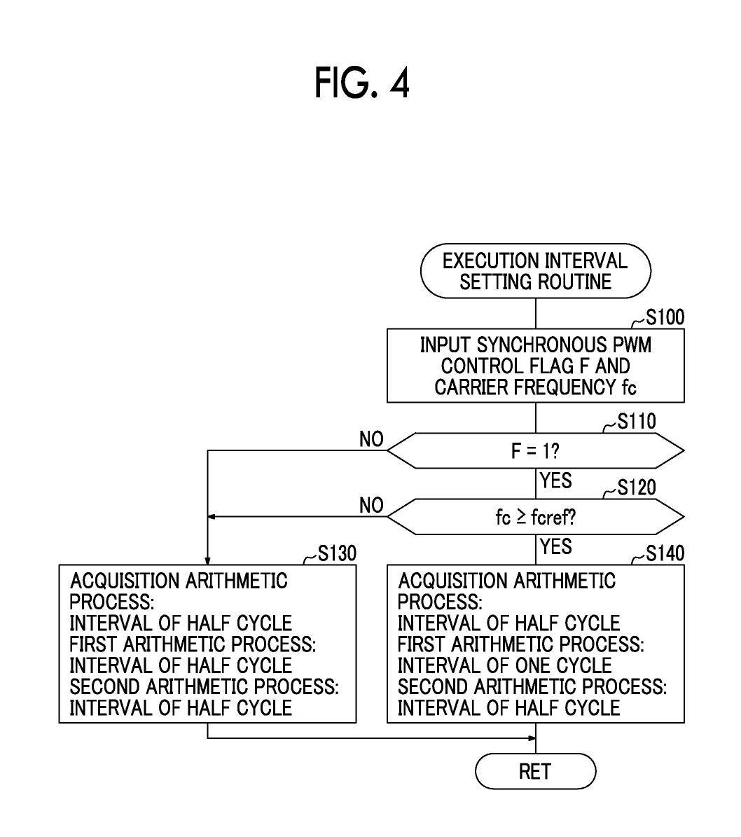

The operation of the drive device that is mounted in the electric vehicle 20 according to the embodiment having the above-mentioned configuration, particularly, the operation when the execution intervals of the acquisition arithmetic process, the first arithmetic process, and the second arithmetic process are set by the microcomputer 51, will be described below. FIG. 4 is a flowchart illustrating an example of an execution interval setting routine which is performed by the microcomputer 51 of the electronic control unit 50. This routine is repeatedly performed.

When the execution interval setting routine is performed, the microcomputer 51 of the electronic control unit 50 receives data such as the carrier frequency fc set in the process of (A3) or the synchronous PWM control flag F (Step S100). Then, the microcomputer 51 ascertains the value of the synchronous PWM control flag F (Step S110) and compares the carrier frequency fc with a threshold value fcref (Step S120). Here, the threshold value fcref has a value which is slightly greater than the predetermined frequency fc1 and for example, 5.5 kHz, 5.6 kHz, or 5.7 kHz can be used.

When it is determined in Step S110 that the value of the synchronous PWM control flag F is 0 or when it is determined in Step S110 that the value of the synchronous PWM control flag F is 1 and it is determined in Step S120 that the carrier frequency fc is less than the threshold value fcref, the acquisition arithmetic process, the first arithmetic process, and the second arithmetic process are set to be performed at intervals of a half cycle of the carrier wave (specifically, at the times of the crest and trough of the carrier wave) (Step S130), and then the routine ends. In this case, the acquisition arithmetic process, the first arithmetic process, and the second arithmetic process are performed at the times of the crest and trough of the carrier wave. Accordingly, it is possible to improve controllability of the motor 32.

When it is determined in Step S110 that the value of the synchronous PWM control flag F is 1 and it is determined in Step S120 that the carrier frequency fc is equal to or greater than the threshold value fcref, the first arithmetic process is set to be performed at intervals of one cycle of the carrier wave (specifically, the times of the troughs of the carrier wave), the acquisition arithmetic process and the second arithmetic process are set to be performed at intervals of a half cycle of the carrier wave (specifically, at the times of the crest and trough of the carrier wave) (Step S140), and then the routine ends. In this case, the acquisition arithmetic process, the first arithmetic process, and the second arithmetic process are performed at the times of the troughs of the carrier wave, and the acquisition arithmetic process and the second arithmetic process are performed at the times of the crests of the carrier wave.

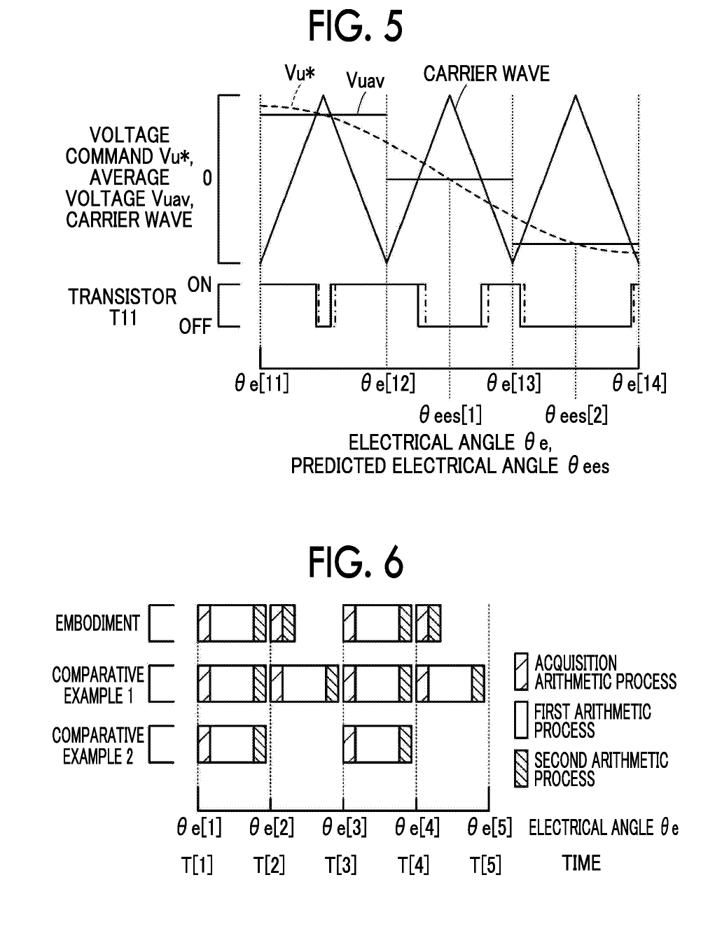

As the carrier frequency fc increases, the interval of one cycle or the interval of a half cycle of the carrier wave decreases and thus the processing load of the microcomputer 51 is likely to increase. Accordingly, when the acquisition arithmetic process, the first arithmetic process, and the second arithmetic process are performed at the intervals of a half cycle of the carrier wave by the microcomputer 51, there is a likelihood that the processing load of the microcomputer 51 will exceed an allowable load and the PWM signal will not be able to be appropriately set. On the other hand, when the acquisition arithmetic process, the first arithmetic process, and the second arithmetic process are performed at intervals of one cycle of the carrier wave by the microcomputer 51, the execution intervals of the acquisition arithmetic process, the first arithmetic process, and the second arithmetic process increase and thus controllability of the motor 32 is likely to deteriorate. FIG. 5 is a diagram illustrating a state in which the PWM signal is generated when the acquisition arithmetic process and the second arithmetic process are performed at intervals of one cycle of the carrier wave (specifically, at the times of the crest and trough of the carrier wave) by the microcomputer 51 of the electronic control unit 50. In FIG. 5, similarly to FIG. 3, a numeral in the predicted electrical angle θees[ ] of the motor 32 means that it has been calculated based on the same numeral in [ ] of the electrical angle θe of the motor 32. In FIG. 5, the predicted electrical angle θees has a value which leads the electrical angle θe by a one and half cycle of the carrier wave. An alternate long and short dash line of the PWM signal for the transistor T11 indicates a state (see FIG. 3) in which the acquisition arithmetic process and the second arithmetic process are performed at intervals of a half cycle of the carrier wave by the microcomputer 51. As can be seen from FIG. 5, the PWM signals for the transistors T11 to T16 are different between the case in which the acquisition arithmetic process and the second arithmetic process are performed at intervals of one cycle of the carrier wave by the microcomputer 51 (see the solid line) and the case in which the acquisition arithmetic process and the second arithmetic process are performed at intervals of a half cycle of the carrier wave by the microcomputer 51 (see the alternate long and short dash line). Accordingly, when the acquisition arithmetic process and the second arithmetic process are performed at intervals of one cycle of the carrier wave by the microcomputer 51, controllability of the motor 32 is more likely to deteriorate in comparison with the case in which the acquisition arithmetic process and the second arithmetic process are performed at intervals of a half cycle of the carrier wave by the microcomputer 51.

In consideration of the above description, in the embodiment, the microcomputer 51 is set to perform the first arithmetic process at intervals of one cycle of the carrier wave and to perform the acquisition arithmetic process and the second arithmetic process at intervals of a half cycle of the carrier wave. Accordingly, it is possible to curb increase in the processing load of the microcomputer 51 by causing the microcomputer 51 to perform the first arithmetic process at intervals of one cycle of the carrier wave, and it is possible to secure controllability of the motor 32 by causing the microcomputer 51 to perform the acquisition arithmetic process and the second arithmetic process at intervals of a half cycle of the carrier wave. That is, it is possible to allow both curbing of the increase in the processing load of the microcomputer 51 and securing of controllability of the motor 32.

In general, the processing load for the second arithmetic process in the microcomputer 51 is less than the processing load for the first arithmetic process. Accordingly, increase in the processing load of the microcomputer 51 when the second arithmetic process is performed at intervals of a half cycle of the carrier wave by the microcomputer 51 is not thought to be much larger than that when the second arithmetic process is performed at intervals of one cycle of the carrier wave by the microcomputer 51. FIG. 6 is a diagram schematically illustrating times at which the acquisition arithmetic process, the first arithmetic process, and the second arithmetic process are performed by the microcomputer 51 of the electronic control unit 50. In FIG. 6, Comparative examples 1 and 2 in addition to the embodiment are illustrated. In Comparative example 1, the acquisition arithmetic process, the first arithmetic process, and the second arithmetic process are performed at intervals of a half cycle of the carrier wave by the microcomputer 51. In Comparative example 2, the acquisition arithmetic process, the first arithmetic process, and the second arithmetic process are performed at intervals of one cycle of the carrier wave by the microcomputer 51. As can be seen from FIG. 6, in the embodiment, it is possible to decrease the processing load of the microcomputer 51 in comparison with Comparative example 1 and it is possible to further improve controllability of the motor 32 in comparison with Comparative example 2.

In the drive device that is mounted in the electric vehicle 20 according to the embodiment, the microcomputer 51 of the electronic control unit 50 performs the first arithmetic process at intervals of one cycle of the carrier wave and performs the second arithmetic process at intervals of a half cycle of the carrier wave, when the value of the synchronous PWM control flag F is 1 and the carrier frequency fc is equal to or greater than the threshold value fcref. Accordingly, it is possible to curb increase in the processing load of the microcomputer 51 by causing the microcomputer 51 to perform the first arithmetic process at intervals of one cycle of the carrier wave, and it is possible to secure controllability of the motor 32 by causing the microcomputer 51 to perform the acquisition arithmetic process and the second arithmetic process at intervals of a half cycle of the carrier wave. That is, it is possible to allow both curbing of the increase in the processing load of the microcomputer 51 and securing of controllability of the motor 32.

In the drive device that is mounted in the electric vehicle 20 according to the embodiment, the microcomputer 51 of the electronic control unit 50 performs the first arithmetic process and the second arithmetic process at intervals of a half cycle of the carrier wave when the value of the synchronous PWM control flag F is 0 or when the value of the synchronous PWM control flag F is 1 and the carrier frequency fc is less than the threshold value fcref, and performs the first arithmetic process at intervals of one cycle of the carrier wave and performs the second arithmetic process at intervals of a half cycle of the carrier wave when the value of the synchronous PWM control flag F is 1 and the carrier frequency fc is equal to or greater than the threshold value fcref. However, regardless of the synchronous PWM control flag F, the microcomputer 51 may perform the first arithmetic process and the second arithmetic process at intervals of a half cycle of the carrier wave when the carrier frequency fc is less than the threshold value fcref, and may perform the first arithmetic process at intervals of one cycle of the carrier wave and perform the second arithmetic process at intervals of a half cycle of the carrier wave when the carrier frequency fc is equal to or greater than the threshold value fcref. Regardless of the synchronous PWM control flag F and the carrier frequency fc, the microcomputer 51 may perform the first arithmetic process at intervals of one cycle of the carrier wave and perform the second arithmetic process at intervals of a half cycle of the carrier wave.

In the drive device that is mounted in the electric vehicle 20 according to the embodiment, the electronic control unit 50 causes the microcomputer 51 to perform the processes of (C1) to (C3) as the second arithmetic process. However, the microcomputer 51 has only to perform at least the process of (C1) as the second arithmetic process. For example, only the process of (C1) as the second arithmetic process may be performed by the microcomputer 51, and the processes of (C2) and (C3) may be performed by hardware (not illustrated) which has received an output from the microcomputer 51.

In the embodiment, the disclosure has been embodied as a drive device that is mounted in the electric vehicle 20 including the motor 32. However, the disclosure may be embodied as a drive device that is mounted in a hybrid vehicle including an engine in addition to the motor 32, may be embodied as a drive device that is mounted in a mobile object such as a vehicle other than an automobile, a ship, or an airplane, or may be embodied as a drive device that is mounted in immobile equipment such as construction equipment.

Correspondence between principal elements of the embodiment and principal elements of the disclosure described in the SUMMARY will be described below. In the embodiment, the motor 32 is an example of the “motor.” The inverter 34 is an example of the “inverter.”

The correspondence between the principal elements in the embodiment and the principal elements of the disclosure described in the SUMMARY does not limit the elements of the disclosure described in the SUMMARY, because the embodiment is an example for specifically describing an aspect of the disclosure described in the SUMMARY. That is, it should be noted that the disclosure described in the SUMMARY has to be construed based on the description of the SUMMARY and the embodiment is only a specific example of the disclosure described in the SUMMARY.

While an embodiment of the disclosure has been described above, the disclosure is not limited to the embodiment and can be modified in various forms without departing from the gist of the disclosure.

The disclosure is applicable to the drive device manufacturing industry.

What is claimed is:

1. A drive device comprising:
a motor;
an inverter configured to drive the motor by switching a plurality of switching elements; and
an electronic control unit being configured to detect an electrical angle of the motor as a detected electrical angle,
the electronic control unit being configured to control the inverter by pulse width modulation control,
the electronic control unit being configured to perform first control at intervals of one cycle of a carrier wave, the first control being control of setting voltage commands of a d axis and a q axis based on a torque command for the motor and the detected electrical angle, and
the electronic control unit being configured to perform second control at intervals of a half cycle of the carrier wave, the second control being control including control of calculating a predicted electrical angle based on the detected electrical angle, the predicted electrical angle being used to generate a pulse width modulation signal.

2. The drive device according to claim 1, wherein
the electronic control unit is configured to perform the first control at intervals of the one cycle of the carrier wave when a frequency of the carrier wave is equal to or greater than a predetermined frequency, and
the electronic control unit is configured to perform the first control at intervals of the half cycle of the carrier wave when the frequency of the carrier wave is less than the predetermined frequency.

3. The drive device according to claim 2, wherein
the electronic control unit is configured to perform the first control at intervals of the one cycle of the carrier wave when synchronous pulse width modulation control of the pulse width modulation control is performed and the frequency of the carrier wave is equal to or greater than the predetermined frequency, and
the electronic control unit is configured to perform the first control at intervals of the half cycle of the carrier wave either when asynchronous pulse width modulation control of the pulse width modulation control is performed or when the frequency of the carrier wave is less than the predetermined frequency.

4. The drive device according to claim 1, wherein
the electronic control unit is configured to set a frequency of the carrier wave such that the frequency of the carrier wave when a rotation speed of the motor is high is greater than the frequency of the carrier wave when the rotation speed of the motor is low.

5. A control method for a drive device, the drive device including a motor, an inverter configured to drive the motor by switching a plurality of switching elements, and an electronic control unit,
the control method comprising:
detecting, by the electronic control unit, an electrical angle of the motor as a detected electrical angle;
controlling, by the electronic control unit, the inverter by pulse width modulation control;
performing, by the electronic control unit, first control of setting voltage commands of a d axis and a q axis based on a torque command for the motor and the detected electrical angle at intervals of one cycle of a carrier wave; and
performing, by the electronic control unit, second control including control of calculating a predicted electrical angle based on the detected electrical angle at intervals of a half cycle of the carrier wave, the predicted electrical angle being used to generate a pulse width modulation signal.
